(19) United States
(12) Patent Application Publication
(10) Pub. No.: US 2014/0138045 A1
(43) Pub. Date: May 22, 2014

(54) COMPRESSED NATURAL GAS REFRIGERATED VEHICLE AND REGULATOR THEREFOR

(71) Applicant: CLEAN VEHICLE SOLUTIONS LLC, W. Nyack, NY (US)

(72) Inventor: Dean L. Sloane, Weston, CT (US)

(73) Assignee: CLEAN VEHICLE SOLUTIONS LLC, W. Nyack, NY (US)

(21) Appl. No.: 14/082,807

(22) Filed: Nov. 18, 2013

Related U.S. Application Data
(60) Provisional application No. 61/728,889, filed on Nov. 21, 2012.

(51) Int. Cl. B60H 1/00

(52) U.S. Cl. CPC B60H 1/00507
USPC 165/42; 62/239; 237/32

(57) ABSTRACT

The present invention concerns in a broad aspect refrigeration systems, and, in particular, mobile refrigeration systems that are powered by compressed natural gas. The system efficiently stores compressed natural gas (CNG) and converts the CNG to natural gas that can be used to power a refrigeration unit throughout the course of a day independently of the refrigeration vehicle's main engine thereby reducing operational costs and minimizing harmful emissions. The system includes a compressed natural gas storage source providing compressed natural gas, a regulator receiving the compressed natural gas and converting it to natural gas by reducing the pressure, a generator adapted to run on natural gas and output power in single or 3-phase mode and to receive the output of the Regulator; and a refrigeration unit powered by the generator.

### CROSS REFERENCE TO RELATED APPLICATIONS

This patent application claims the benefit of priority from U.S. Provisional Patent Application Ser. No. 61/728,889, filed on Nov. 21, 2012, entitled “COMPRESSED NATURAL GAS REFRIGERATED VEHICLE AND REGULATOR THEREFOR,” which is hereby incorporated by reference as if set forth in its entirety herein.

### TECHNICAL FIELD OF THE INVENTION

This invention relates to refrigeration systems, and, in particular, mobile refrigeration systems that are powered by compressed natural gas.

### BACKGROUND OF THE INVENTION

Most internal combustion engines that are commonly found in vehicles, and generators and the like utilize gasoline or diesel as fuels. There are, however, several well-known problems associated with using gasoline and diesel as fuels for such applications. Many of these problems are associated with the emissions from combustion which contribute to unhealthy air pollution, global warming, and acid rain. Another problem concerning gasoline and diesel as fuels for vehicles relates to the unequitable world-wide distribution of oil resources affecting cost. Many countries rely heavily, if not completely, on the importation of oil to meet their demands for gasoline or diesel fuel.

Because of the well-known problems associated with gasoline and diesel as fuels for internal combustion engines, much effort has gone into developing alternative fuels for vehicles in recent years. Natural gas is recognized as an alternative fuel to gasoline or diesel for internal combustion engine applications. Natural gas has many advantages over gasoline or diesel as a vehicle fuel. Perhaps most importantly, natural gas burns much cleaner than gasoline or diesel fuel and lowers emissions dramatically, reducing the environmental impact of internal combustion engines. Engines burning natural gas remain cleaner longer, which results in less wear on the engine, less degradation of fuel efficiency and emissions cleanliness over time, and less frequent and lower service and repair costs. It is also much less expensive than gasoline or diesel fuel for an equivalent energy content. Also, natural gas is a plentiful natural resource within the United States. Further, natural gas is safer because it rises and dissipates into the air, rather than settling like gasoline or diesel fuel.

Refrigeration systems that are commonly found in vehicles for delivering goods that are kept at low temperatures are well known in the art. Most refrigerated vehicles have a main engine that runs on gasoline or diesel fuel to move the vehicle as well as a secondary engine to power the refrigeration unit. The secondary engine commonly runs on natural gas. One drawback to such refrigerated vehicles is that the refrigeration system usually requires both the main engine and secondary engine to work in concert to power the refrigeration unit. This is a result of the limited capacity for storing natural gas, in its uncompressed state. Due to limited storage capacity, the secondary engine cannot be run constantly throughout a workday without recharging the natural gas storage tanks. Accordingly, even when the refrigerated vehicle is idle during deliveries, the primary engine is often running to help power the refrigeration system. This is not only leads to high fuel consumption by the primary engine but also contributes to increased emissions that are harmful to the environment.

Accordingly it would be beneficial to provide a vehicle based refrigeration system that can store sufficient quantities of compressed natural gas (CNG) and can convert CNG to natural gas to power a refrigeration unit throughout the course of a day independent of the refrigeration vehicle's main engine. These considerations are addressed by the present invention.

### SUMMARY OF THE INVENTION

The present invention concerns, in a broad aspect, refrigeration systems, and, in particular, mobile refrigeration systems that are powered by compressed natural gas. The system includes a compressed natural gas storage source providing compressed natural gas, a regulator receiving the compressed natural gas and converting it to natural gas by reducing the pressure, a generator adapted to run on natural gas and output power in single or 3-phase mode and to receive the output of the Regulator and a refrigeration unit powered by the generator.

These and other aspects, features, steps and advantages can be further appreciated from the accompanying drawing Figures and description of certain illustrative embodiments.

### BRIEF DESCRIPTION OF THE DRAWINGS

FIG. 1 is a diagram illustrating an exemplary configuration of a compressed natural gas refrigeration system.

FIG. 2 depicts a regulator for use in an exemplary configuration of a compressed natural gas refrigeration system.

FIG. 3 is a diagram illustrating an exemplary configuration of a compressed natural gas oven/heating system.

FIG. 4 is a diagram illustrating an exemplary configuration of a compressed natural gas refrigeration and oven/heating system.

### DETAILED DESCRIPTION OF CERTAIN EMBODIMENTS OF THE INVENTION

Illustrative embodiments of the invention will be described more fully hereinafter with reference to the accompanying drawings, in which some, but not all, embodiments of the invention are shown. Indeed, the invention may be embodied in many different forms and should not be construed as being limited to the embodiments set forth herein; rather, these embodiments are provided so that this disclosure will satisfy applicable legal requirements. Like numbers refer to like elements throughout.

By way of overview and introduction, described herein is a system to power a refrigeration unit of a refrigerated vehicle such as a delivery vehicle, with natural gas. The system includes a generator that runs on natural gas to provide electricity to a refrigeration unit. The system also includes one or more compressed natural gas (CNG) storage tanks, that are sized to carry at least the amount of CNG required to power the generator and refrigeration unit for a typical work day. By storing CNG, significantly more fuel can be stored as compared to natural gas (NG). In accordance with a salient aspect of the invention, the system also includes a regulator to convert the compressed natural gas to natural gas such that it is usable to fuel the generator. Accordingly, the system allows a vehicle to run a natural gas based refrigeration system throughout a typical work-day without relying on the vehicle's main engine for additional power.

Also by way of overview, the described herein is a system to power an oven within a truck or other vehicle with natural gas. The system includes a generator that runs on natural gas to provide electricity to the oven. The system also includes one or more compressed natural gas (CNG) storage tanks, that are sized to carry at least the amount of CNG required to power the generator and oven for a typical work day. By storing CNG, significantly more fuel can be stored as compared to natural gas (NG). In accordance with a salient aspect of the invention, the system also includes a regulator to convert the compressed natural gas to natural gas such that it is usable to fuel the generator. Accordingly, the system allows a vehicle to run a natural gas based oven/heating system throughout a typical work-day without relying on the vehicle's main engine for additional power.

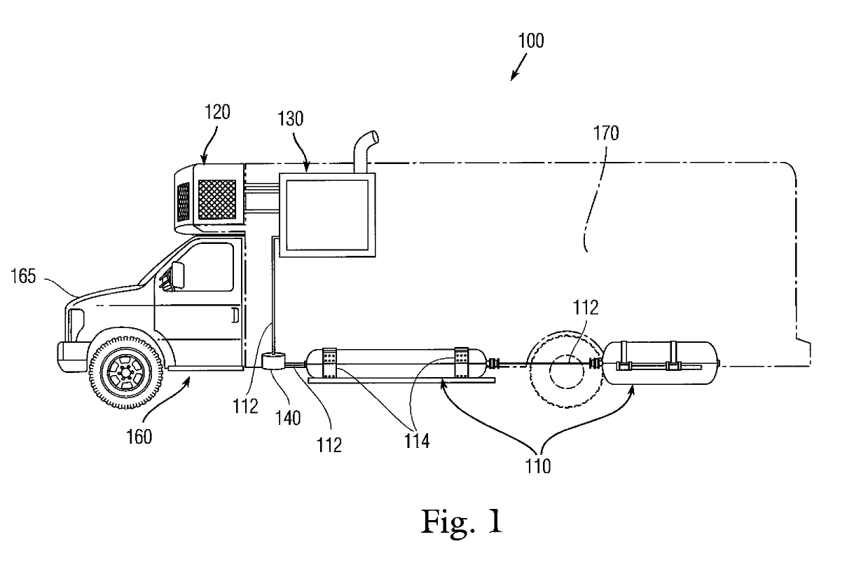

In a variation of the foregoing, in accordance with a broad aspect of the invention, the vehicle can have a system as noted above which provides power to both a refrigeration unit and to an oven or other heating system by tapping the generated power for both the refrigeration unit and the oven/heating system. This arrangement has utility in connection with mobile restaurant and catering services as well as recreational vehicles and delivery services. FIG. 1 depicts a system 100 for powering a refrigeration unit using compressed natural gas according to an exemplary embodiment. The system 100 is shown in an exemplary implementation in a refrigerated delivery truck 160 having a main engine 165 and a storage compartment 170. The system 100 includes a refrigeration unit 120 for cooling the interior of the storage compartment. The refrigeration unit can be of conventional design and, in and of itself, forms no part of the present invention. The cooling from the refrigeration unit 120 is directed within the vehicle, as appropriate, within ducts 122 or the like, for the intended cooling application and location.

Electrical power for the refrigeration unit is supplied by a generator 130. The generator preferably runs on natural gas and can supply single phase or three phase power to the refrigeration unit as is well understood in the art. The generator is sized according to the total power requirements of the refrigeration unit, the size of the storage compartment 170 and the type of insulation used in the storage compartment.

The system also includes a CNG storage source 110 for safely storing CNG that is ultimately used as fuel for the generator. The CNG storage source consists of one or more tanks that can withstand the structural stress of containing CNG under very high pressure and are suitable for installation in a vehicle. In an exemplary embodiment, the CNG is stored in the storage source at approximately 3600 psi, however it should be understood that the storage source can accommodate higher or lower CNG pressures. The CNG storage source is sized to meet or exceed the amount of CNG required to power the generator and refrigeration unit for an entire work day without requiring supplemental power from the main engine 165. However, it should be understood that a larger or smaller CNG source can be used to adjust the operational capacity of the system. The storage source 110 is secured to the vehicle by one or more mounting brackets 114. It should also be understood that the storage source also includes a fill port (not shown) to allow the storage source to be re-filled with CNG as needed.

The CNG storage source is connected to the regulator and delivers CNG to the regulator via plumbing 112 that can withstand pressures in excess of 3600 psi, such as stainless steel plumbing. In embodiments where the storage source comprises multiple storage tanks, the tanks can also be interconnected by plumbing, such as high pressure stainless steel plumbing. Similarly, the regulator is connected to the generator and delivers natural gas to the generator via the plumbing 112. It should be understood that the stainless steel plumbing connecting the regulator to the generator is not required to withstand the same high internal pressure as the plumbing that delivers CNG from the storage source to the regulator.

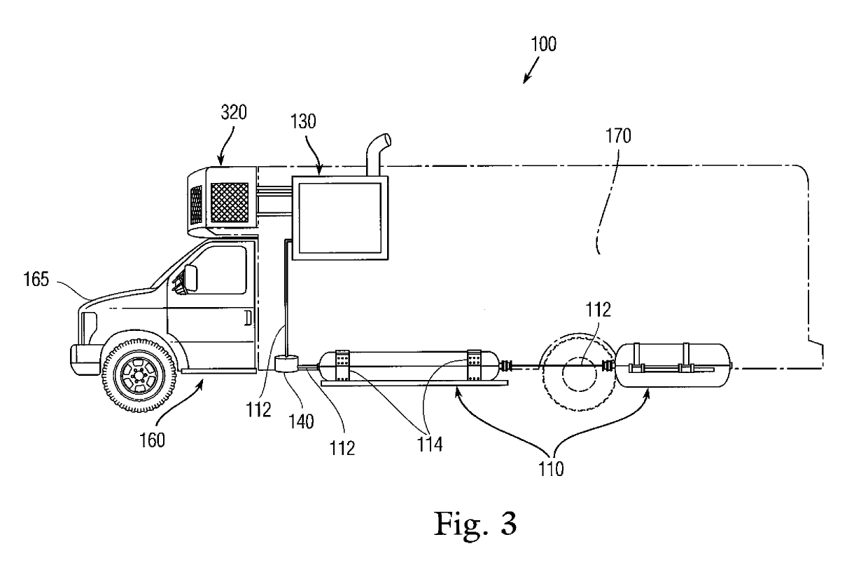

As shown in FIG. 3, a system configured to provide power to an oven or other heating system 320 includes substantially the same equipment, except that it is connected to oven/heating unit 320 rather than to refrigeration unit 120. The oven/heating unit 320 can be of conventional design and, in and of itself, forms no part of the present invention. The oven/heating unit has heat directed within the vehicle, as appropriate, within ducts 322 or the like, for the intended heating/cooking application and location.

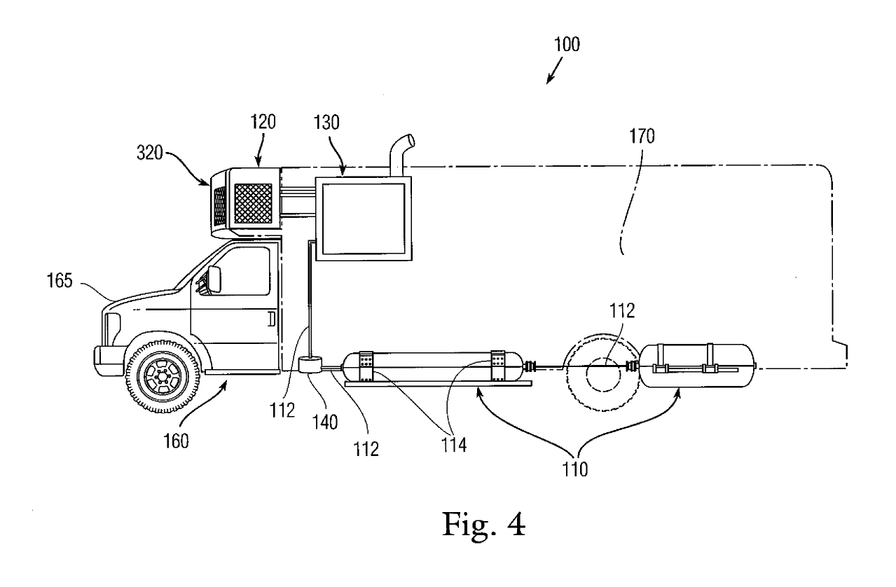

As shown in FIG. 4, a system configured to provide power to both the refrigeration unit 120 and the oven or other heating system 320 includes substantially the same equipment as described above, except that it includes both the refrigeration unit and the oven/heating unit 320.

In all other respects, the arrangement of FIG. 4 is the same as described herein in connection with the other arrangements.

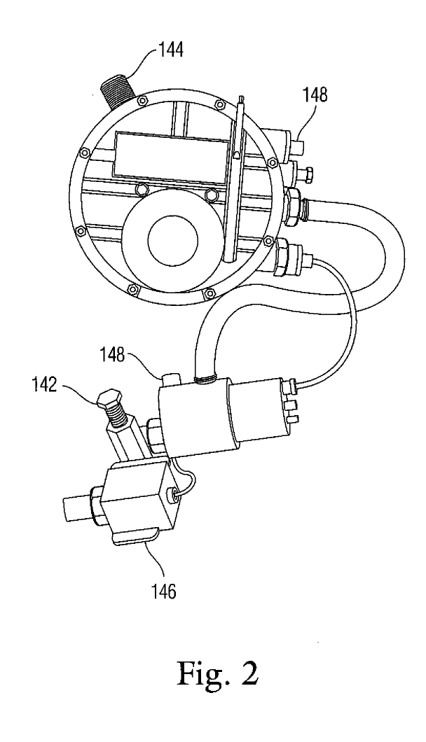

FIG. 2 depicts a regulator 140 according to an exemplary embodiment. The regulator includes an inlet 142. The inlet connects to the plumbing from the CNG storage source and receives CNG from the storage source. The regulator controls the flow of CNG through the regulator, thereby reducing the pressure of the gas that flows out of the regulator. In an exemplary embodiment the regulator reduces the pressure of the CNG from around 3600 psi as stored in the CNG tanks to around 4 psi. Once at the lower pressure, the natural gas is suitable to be used as fuel for the generator. It should be understood that the pressure of the CNG flowing into the regulator and the pressure of the natural gas flowing out of the regulator can be varied to suit the particular generator fuel delivery requirements. The lower pressure natural gas flows out of the regulator through the outlet 144 and can be supplied to the generator via plumbing. The regulator can also include an electrically operated safety valve 146 at the inlet that can close to prevent CNG from flowing into the regulator as may be necessary in the event of a system shut down, mechanical failure and the like.

Because the expansion of a gas from high pressure to low pressure absorbs energy in the form of heat, the regulator can also include a heater fluid circulation system to prevent the regulator and its components from freezing. The fluid circulation system can include two connections 148 for the inflow and/or outflow of heated fluid. The system constantly receives heated fluid that is cooled by the gas passing through the regulator, and expels the cooled fluid. The fluid can be circulated to and from the regulator via plumbing through an external heat source which can include but is not limited to the generator.

Thus, while there have been shown, described, and pointed out fundamental novel features of the invention as applied to several embodiments, it will be understood that various omissions, substitutions, and changes in the form and details of the devices illustrated, and in their operation, may be made by those skilled in the art without departing from the spirit and scope of the invention. Substitutions of elements from one described embodiment to another are also fully intended and contemplated. It is also to be understood that the drawings are not necessarily drawn to scale, but that they are merely conceptual in nature. The invention is defined solely with regard to the claims appended hereto, and equivalents of the recitations therein.

What is claimed is:

1. A system for use in a vehicle, comprising:
a compressed natural gas storage source providing compressed natural gas;
a regulator receiving the compressed natural gas and converting it to natural gas by reducing the pressure;
a generator adapted to run on natural gas and output power in single or 3-phase mode and to receive the output of the Regulator; and
a refrigeration unit powered by the generator to provide cooling within the vehicle.

2. The system of claim 1, wherein the regulator receives compressed natural gas at 3600 psi and reduces the pressure to 4 psi.

3. The system of claim 1, wherein the regulator includes an electrical safety valve.

4. The system of claim 1, wherein the regulator includes a heating fluid circulation system to heat the CNG provided to the regulator.

5. The system of claim 4, wherein the heating fluid circulation system circulates heat between the regulator and the generator.

6. A system for use in a vehicle, comprising:
a compressed natural gas storage source providing compressed natural gas;
a regulator receiving the compressed natural gas and converting it to natural gas by reducing the pressure;
a generator adapted to run on natural gas and output power in single or 3-phase mode and to receive the output of the Regulator; and
a heating unit powered by the generator to provide heat within the vehicle.

7. The system of claim 6, wherein the regulator receives compressed natural gas at 3600 psi and reduces the pressure to 4 psi.

8. The system of claim 6, wherein the regulator includes an electrical safety valve.

9. The system of claim 6, wherein the regulator includes a heating fluid circulation system to heat the CNG provided to the regulator.

10. The system of claim 9, wherein the heating fluid circulation system circulates heat between the regulator and the generator.

11. The system of claim 6, further comprising ducts extending from the heating unit to a location within the vehicle.

12. A system for use in a vehicle, comprising:
a compressed natural gas storage source providing compressed natural gas;
a regulator receiving the compressed natural gas and converting it to natural gas by reducing the pressure;
a generator adapted to run on natural gas and output power in single or 3-phase mode and to receive the output of the Regulator;
a refrigeration unit powered by the generator to provide cooling within the vehicle; and
a heating unit powered by the generator to provide heat within the vehicle.

13. The system of claim 12, wherein the regulator receives compressed natural gas at 3600 psi and reduces the pressure to 4 psi.

14. The system of claim 12, wherein the regulator includes an electrical safety valve.

15. The system of claim 12, wherein the regulator includes a heating fluid circulation system to heat the CNG provided to the regulator.

16. The system of claim 15, wherein the heating fluid circulation system circulates heat between the regulator and the generator.

17. The system of claim 12, further comprising ducts extending from the heating unit to a location within the vehicle.

18. The system of claim 12, further comprising ducts extending from the refrigeration unit to a location within the vehicle.

19. The system of claim 12, further comprising ducts extending from each of the refrigeration and heating units to respective locations within the vehicle.
